(19) United States
(12) Patent Application Publication
(10) Pub. No.: US 2014/0272546 A1
(43) Pub. Date: Sep. 18, 2014

(54) METHOD AND APPARATUS FOR ASSEMBLY OF A RUGGED SUBMERSIBLE BATTERY ENCLOSURE

(71) Applicant: THALES DEFENSE & SECURITY, INC., Clarksburg, MD (US)

(72) Inventors: Mehrdad BADIE, Gaithersburg, MD (US); Bradley Poston, Rockville, MD (US); Dennis Crossen, Damascus, MD (US); Tony Maczis, Mount Airy, MD (US); Danny Amato, Hackensack, NJ (US); Tudor Agapescu, Hackensack, NJ (US); Vic Adam, Hackensack, NJ (US); Anthony Puccetti, Hackensack, NJ (US)

(73) Assignee: Thales Defense & Security, Inc., Clarksburg, MD (US)

(21) Appl. No.: 14/206,965

(22) Filed: Mar. 12, 2014

Related U.S. Application Data
(60) Provisional application No. 61/779,926, filed on Mar. 13, 2013.

(51) Int. Cl. H01M 2/08

(52) U.S. Cl. CPC H01M 2/08
USPC 429/163; 156/91

(57) ABSTRACT

A battery enclosure includes a first enclosure half comprising a plurality of lock extensions, and a second enclosure half comprising a plurality of lock extension receiving features, wherein each of the plurality of lock extensions is configured to cooperatively interoperate with one of the plurality of lock extension receiving features so as to compress a first adhesive material disposed between the first enclosure half and the second enclosure half providing a waterproof adhesive seal between the first enclosure half and the second enclosure half.

### CLAIM OF PRIORITY UNDER 35 U.S.C. §119

This application claims the benefit of and priority to U.S. Provisional Patent Application No. 61/779,926, titled “Method and Apparatus for Assembly of a Rugged Submersible Battery Enclosure,” filed Mar. 13, 2013, the disclosure of which is hereby incorporated in its entirety by reference herein.

### BACKGROUND

1. Field

Aspects of the present invention generally relate to a battery pack, and more particularly to a method and apparatus for assembly of a rugged submersible battery enclosure.

2. Introduction

Some military battery enclosure designs rely on pour-in-place adhesives as a means of sealing and providing mechanical strength. One problem with these designs is the need for clamping together the adhering portions of the enclosure for a period of time in order to allow for the adhesive to cure. Because the curing process requires time, the battery enclosure is not available for use immediately after assembly. Furthermore, such enclosure designs may exhibit inconsistency in seal strength and may ultimately result in a weak seal that is not waterproof.

Therefore, there exists, among other things, an unmet need in the art for a method of battery enclosure assembly without the need for long cure times that can be handled immediately after assembly, while providing a consistently rugged waterproof seal.

### SUMMARY

According to an aspect of the present invention, a battery enclosure may include a first enclosure half comprising a plurality of lock extensions; and a second enclosure half comprising a plurality of lock extension receiving features, wherein each of the plurality of lock extensions is configured to cooperatively interoperate with one of the plurality of lock extension receiving features so as to compress a first adhesive material disposed between the first enclosure half and the second enclosure.

According to another aspect of the present invention, a method of assembling a battery enclosure having a first enclosure half comprising a plurality of lock extensions, a second enclosure half comprising a plurality of lock extension receiving features, and a first adhesive material disposed between the first enclosure half and the second enclosure half, the method may include aligning each of the plurality of lock extensions with a corresponding one of the plurality of lock extension receiving features; and compressing together the first enclosure half and the second enclosure half such that each of the plurality of lock extensions cooperatively interoperates with the corresponding one of the plurality of lock extension receiving features, and the first adhesive material is compressed between the first enclosure half and the second enclosure half.

It is understood that other aspects of the invention will become readily apparent to those skilled in the art from the following detailed description, wherein various aspects of the present invention are shown and described by way of illustration only. As will be understood, the present invention is capable of other and different variations and its several details are capable of modification in various other respects, all without departing from the scope of the invention. Accordingly, the drawings and detailed description are to be regarded as illustrative in nature and not as restrictive.

### BRIEF DESCRIPTION OF THE DRAWINGS

These and other sample aspects of the disclosure will be described in the detailed description and the appended claims that follow, and in the accompanying drawings, wherein:

FIG. 1 is an example representative diagram illustrating a battery enclosure in accordance with aspects of the present invention;

FIGS. 2A-2E show example representative diagrams illustrating a battery enclosure in accordance with aspects of the present invention; and

FIG. 3 illustrates an example flow diagram of a method for assembling a battery enclosure in accordance with aspects of the present invention.

In accordance with common practice, the various features illustrated in the drawings may be simplified for clarity. Thus, the drawings may not depict all of the components of a given apparatus or method. In addition, like reference numerals may be used to denote like features throughout the specification and figures.

### DETAILED DESCRIPTION

Various aspects of the present invention are described below. It should be apparent that the teachings herein may be incorporated in a wide variety of forms and that any specific structure, function, or both being disclosed herein may be merely representative. Based on the teachings herein, one skilled in the art should appreciate that an aspect disclosed may be implemented independently of any other aspects, and that two or more aspects may be combined in various ways. For example, an apparatus may be implemented or a method may be practiced using and/or excluding any number of the aspects set forth herein. In addition, such an apparatus may be implemented or such a method may be practiced using other structure, functionality, or structure and functionality, in addition to or other than one or more of the aspects set forth herein. An aspect may comprise one or more elements of a claim.

Various aspects of the present invention solve the above-identified needs, as well as others, via devices, methods, and systems capable of providing a battery enclosure assembly that may be handled immediately after assembly while providing a rugged waterproof seal.

FIG. 1 is an example representative diagram illustrating a battery enclosure 100 in accordance with aspects of the present invention. The battery enclosure 100 may include a first enclosure half 102 and a second enclosure half 104. The first enclosure half 102 and the second enclosure half 104 of this example both include locking sections 120, 122, 124, 126, 128, 130, where each of the locking sections may include a snap finger 106 or other lock extension and a locking slot 108 or other lock extension receiving feature. For example, the first enclosure half 102 may include a locking slot 108 in each of the locking sections 120, 122, 124, 126, 128, 130; and the second enclosure half 104 may include a snap finger 106 in each of the locking sections 120, 122, 124, 126, 128, 130.

FIGS. 2A-2E show example representative diagrams illustrating the battery enclosure 100 in accordance with aspects of the present invention. As shown in FIGS. 2C and 2E, the snap fingers 106 and the locking slots 108, when joined together at their respective locking sections 120-130, allow the first enclosure half 102 and the second enclosure half 104 to align, lock in place, and remain stable.

The first enclosure half 102 and the second enclosure half 104 may also include a predetermined gap around the perimeter of each of the respective first and second enclosure halves 102, 104. The gap may include a first adhesive material 110 (e.g., foam double sided tape, such as 3M 4941 VHB made by 3M Company of St. Paul, Minn.) having a predetermined thickness (e.g., 0.045″). When the first enclosure half 102 and the second enclosure half 104 are snap closed together via the snap fingers 106 and the locking slots 108, the first adhesive material 110 is compressed, creating a gasket and ensuring adhesion to both enclosure halves 102, 104. In addition to the first adhesive material 110, one or both of the first and second enclosure halves 102, 104 may have applied to their respective locking slots 112 of the locking sections 120-130 a second adhesive material 112 (e.g., epoxy, such as 3M DP 100 epoxy made by 3M Company of St. Paul, Minn.) prior to locking together the first and second enclosure halves 102, 104. The second adhesive material 112 may be used to ensure that in the event of a drop, shock, or violent vibration, for example, the snap fingers do not bend, thus preventing or reducing the risk of the first and second enclosure halves 102, 104 to come apart.

In this manner, the enclosure 100 may provide a consistent and uniform gasket seal that is waterproof up to a predetermined depth (e.g., 2 meters) while minimizing assembly time through the use of both a first adhesive material 110 (e.g., foam tape) with pressure sensitive adhesive on each side of the adhesive material 110, and snap fingers 106 reinforced with a second adhesive material 112 (e.g., epoxy) to provide mechanical strength.

FIG. 3 illustrates an example flow diagram of a method 200 for assembling a battery enclosure in accordance with aspects of the present invention. As shown in FIG. 3, in block 202, each of a plurality of lock extensions on a first enclosure half may be aligned with a corresponding one of a plurality of lock extension receiving features on a second enclosure half.

In block 204, a second adhesive material may be disposed in at least one of the plurality of lock extension receiving features, the second adhesive material being configured to reinforce a tensile strength of at least one of the lock extensions.

In block 206, the first enclosure half and the second enclosure half may be compressed together such that each of the plurality of lock extensions cooperatively interoperates with the corresponding one of the plurality of lock extension receiving features, and a first adhesive material is compressed between the first enclosure half and the second enclosure half.

While aspects of the present invention have been described in connection with preferred implementations, it will be understood by those skilled in the art that variations and modifications described above may be made without departing from the scope hereof. Other aspects will be apparent to those skilled in the art from a consideration of the specification or from a practice of the aspects of the invention disclosed herein.

What is claimed is:

1. A battery enclosure, comprising:
a first enclosure half comprising a plurality of lock extensions; and
a second enclosure half comprising a plurality of lock extension receiving features,
wherein each of the plurality of lock extensions is configured to cooperatively interoperate with one of the plurality of lock extension receiving features so as to compress a first adhesive material disposed between the first enclosure half and the second enclosure.

2. The battery enclosure of claim 1, wherein at least one of the plurality of lock extensions comprises a snap finger.

3. The battery enclosure of claim 1, wherein at least one of the plurality of lock extension receiving features comprises a locking slot.

4. The battery enclosure of claim 1, wherein the first adhesive material provides an adhesive waterproof seal between the first enclosure half and the second enclosure half.

5. The battery enclosure of claim 1, wherein the first adhesive material is disposed along a perimeter of at least one of the first and second enclosure halves.

6. The battery enclosure of claim 1, further comprising:
a second adhesive material disposed in at least one of the plurality of lock extension receiving features, the second adhesive material being configured to reinforce a tensile strength of at least one of the lock extensions.

7. A method of assembling a battery enclosure having a first enclosure half comprising a plurality of lock extensions, a second enclosure half comprising a plurality of lock extension receiving features, and a first adhesive material disposed between the first enclosure half and the second enclosure half, the method comprising:
aligning each of the plurality of lock extensions with a corresponding one of the plurality of lock extension receiving features; and
compressing together the first enclosure half and the second enclosure half such that each of the plurality of lock extensions cooperatively interoperates with the corresponding one of the plurality of lock extension receiving features, and the first adhesive material is compressed between the first enclosure half and the second enclosure half.

8. The method of claim 7, wherein at least one of the plurality of lock extensions comprises a snap finger.

9. The method of claim 7, wherein at least one of the plurality of lock extension receiving features comprises a locking slot.

10. The method of claim 1, wherein the first adhesive material provides an adhesive waterproof seal between the first enclosure half and the second enclosure half.

11. The method of claim 7, wherein the first adhesive material is disposed along a perimeter of at least one of the first and second enclosure halves.

12. The method of claim 7, further comprising:
disposing a second adhesive material in at least one of the plurality of lock extension receiving features, the second adhesive material being configured to reinforce a tensile strength of at least one of the lock extensions.
